(19) United States
(12) Patent Application Publication
(10) Pub. No.: US 2012/0199447 A1
(43) Pub. Date: Aug. 9, 2012

(54) TRACTION DEVICE, PARTICULARLY FOR PRODUCTS TO BE PACKAGED

(75) Inventor: Francesco Maria Bernardi, Bologna (IT)

(73) Assignee: TISSUE MACHINERY COMPANY S.P.A., Granarolo Dell'Emilia (IT)

(21) Appl. No.: 13/381,848

(22) PCT Filed: Jul. 2, 2009
(86) PCT No.: PCT/EP09/58361

§ 371 Date: Apr. 25, 2012

(51) Int. Cl. B65G 17/32

(52) U.S. Cl. 198/867.02

(57) ABSTRACT

A traction device (1), particularly for products to be packaged, comprising: at least two grip elements (10a, 10b), which can move along a predefined closed path (2) and can engage products (3) to be packaged, and an apparatus for moving the at least two grip elements (10a, 10b) along the closed path (2). The traction device (1) comprises means for varying the distance between one of the grip elements (10a, 10b) and the other one of the grip elements (10b, 10a), during their movement along the closed path (2).

### TECHNICAL FIELD

The present invention relates to a traction device, particularly for products to be packaged.

### BACKGROUND ART

In the field of packaging machines, for various types of article, and particularly for rolls of paper (for example absorbent paper or toilet paper), machines are widespread which are capable of packaging a predefined number of rolls in order to provide the packaging unit that is typically sold to the final consumer.

According to a known constructive solution, these machines are provided first of all with devices for feeding the rolls, which are then picked up by handling means, for example conveyor belts or platforms. Along such means there are elements capable of diverting the flow of part of the rolls in order to arrange them as a whole according to multiple rows or layers.

Once the rolls have been arranged in the desired configuration, they are in practice ready for providing the wrapping cycle, to perform which the rolls are delivered to a traction device, for example by means of a lifting unit (constituted typically by a pusher that can move along its own axis), together with the film designed to wrap the rollers in order to provide the package.

Such traction device is capable of moving the rolls in the final configuration thus obtained, while the subsequent steps for performing the wrapping cycle, i.e., the wrapping of the rolls by means of the film, folded by appropriately provided elements, and the heat-sealing of such film in order to close the package, are performed on such rolls.

Typically, the above-mentioned traction devices are constituted by a plurality of grip elements that can move along a substantially annular path and are usually each constituted by a pair of carriages on which sets of teeth are mounted. In order to adapt to the various formats of the packs to be treated, the grip elements then offer various possibilities to adjust their configuration. The device is completed by a motor that is capable of moving simultaneously all the grip elements along the annular path.

One drawback caused by the adoption of this type of constructive solution is linked to the cycle time with which the traction device operates: with reference to the operation described above, the cycle time must simultaneously adapt to the rate with which the rolls are delivered by the upstream elements and harmonize with the downstream processing steps, including the heat-sealing step, which is often particularly critical.

The need to comply with the timings of the various upstream and downstream steps (often dictated by constraints that are typical of the type of process being performed, consider for example the times required by heat-sealing) in practice does not allow to vary the cycle time at will in order to adapt it to the desired production rate, except to the detriment of the subsequent steps of the wrapping cycle, which is thus not optimized.

### DISCLOSURE OF THE INVENTION

The aim of the present invention is to solve the above-mentioned drawback, by providing a traction device for products to be packaged which allows optimization of the wrapping cycle, rendering the steps upstream of the step for inserting the products in the traction device independent of the downstream steps.

Within this aim, an object of the invention is to provide a traction device that allows a reduction of the moving masses, for consequent structural simplification.

Another object of the invention is to provide a traction device that ensures high reliability in operation.

Another object of the invention is to provide a traction device that can be obtained easily starting from commonly commercially available elements and materials.

Another object of the invention is to provide a traction device that has a low cost, is relatively simple to provide in practice and is safe in application.

This aim and these and other objects, which will become better apparent hereinafter, are achieved by a traction device, particularly for products to be packaged, comprising: at least two grip elements, which can move along a predefined closed path and can engage products to be packaged, and an apparatus for moving said at least two grip elements along said closed path, characterized in that it comprises means for varying the distance between one of said grip elements and the other one of said grip elements, during their movement along said closed path.

### BRIEF DESCRIPTION OF THE DRAWINGS

Further characteristics and advantages of the invention will become better apparent from the following detailed description of some preferred but not exclusive embodiments of the traction device according to the invention, illustrated by way of non-limiting example in the accompanying drawings, wherein:

FIG. 1 is a schematic side elevation view of the traction device according to the invention;

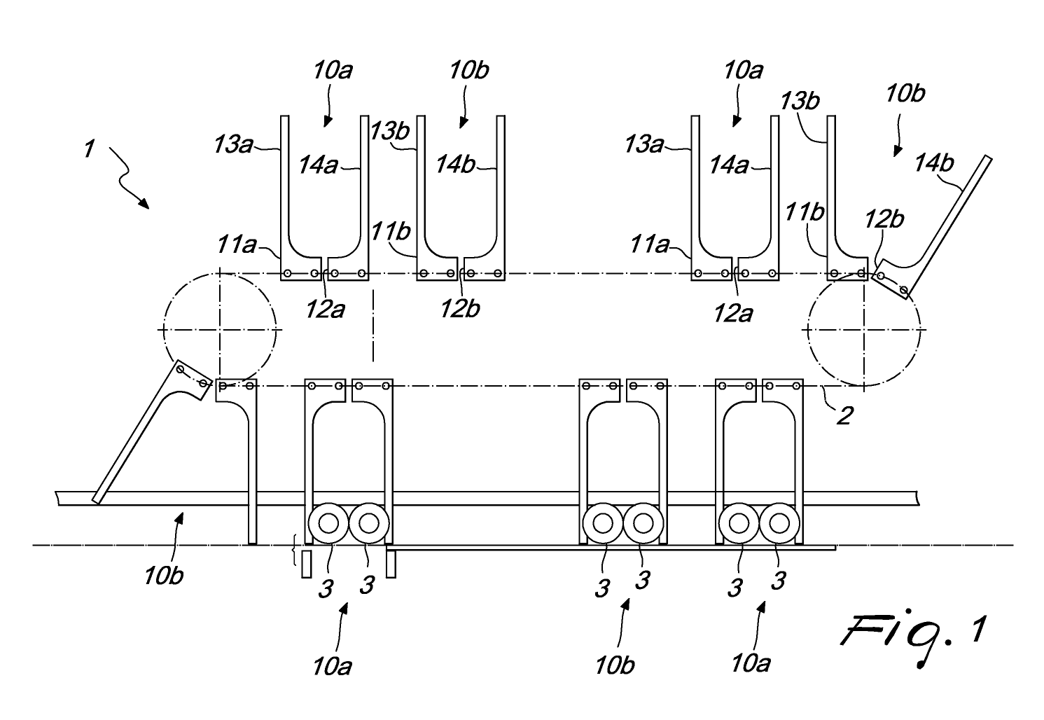

FIG. 2 is a view of a detail of FIG. 1, illustrating two grip elements;

FIG. 3 is a top view of a connection diagram of a movement apparatus;

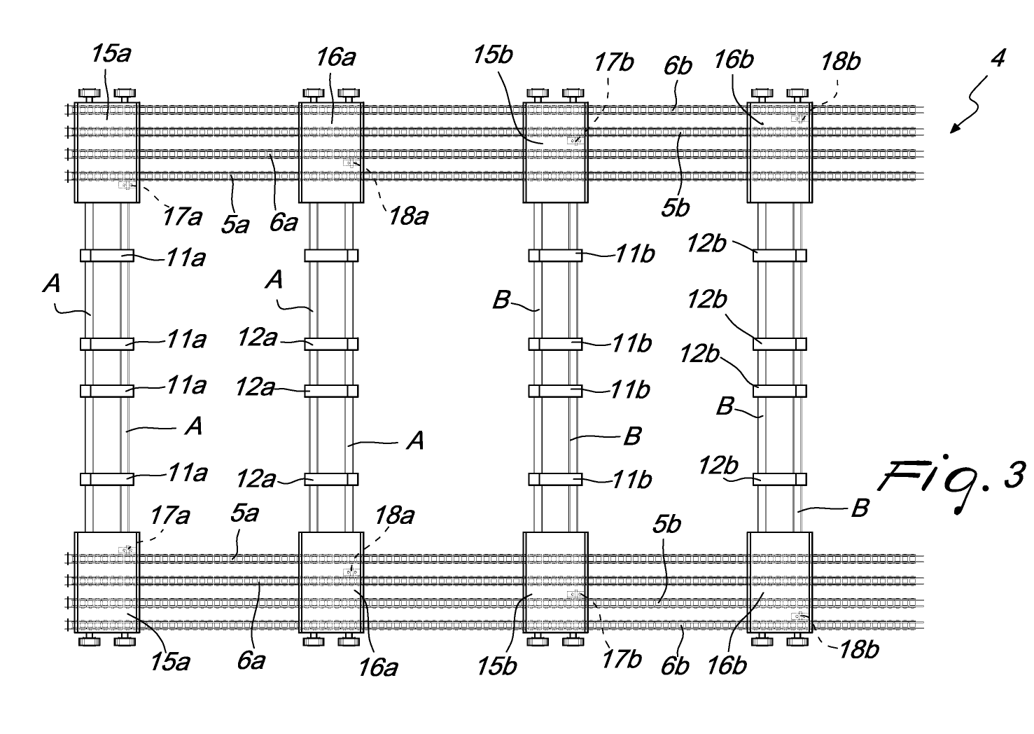

FIG. 4 is a front view of the same connection diagram of FIG. 3.

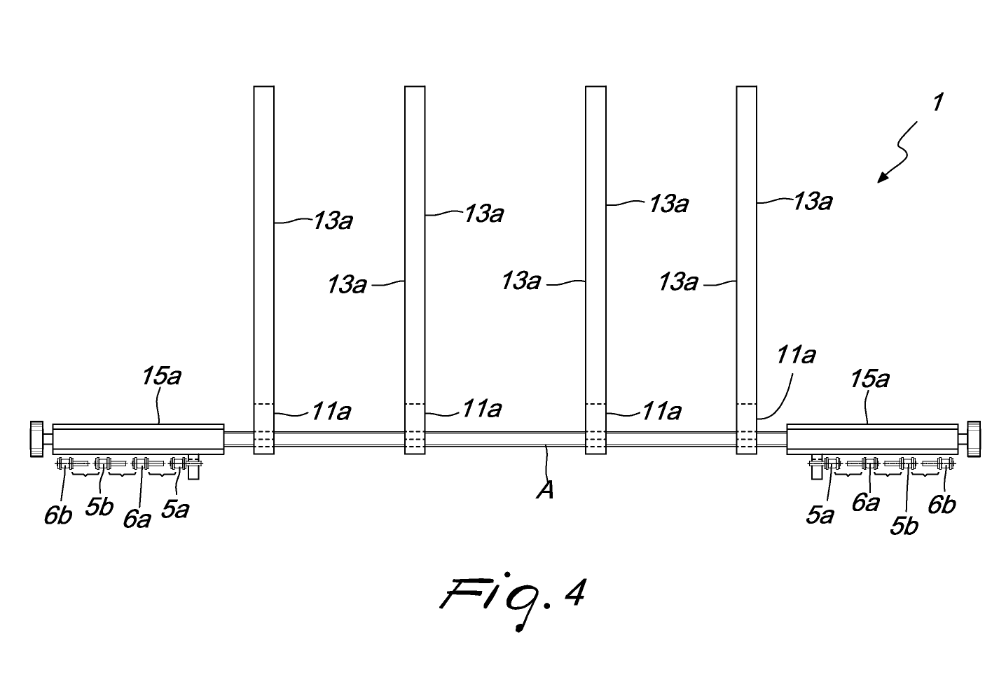

### WAYS OF CARRYING OUT THE INVENTION

With reference to the figures, a traction device according to the invention, generally designated by the reference numeral 1, comprises two grip elements 10a, 10b, which can move along a predefined closed path 2 and engage products 3 to be packaged. The products 3 are for example of the type of rolls of toilet paper, absorbent paper or the like.

The rolls are delivered to the grip elements 10a, 10b for example by a lifting unit, constituted by a pusher that can perform a translational motion. The spatial configuration of the rolls (typically a set of products 3 arranged along multiple rows and layers) is obtained in the preceding steps of the wrapping cycle and must be maintained by the grip elements 10a, 10b during traction, while the subsequent processing steps are performed.

The closed path 2 has, for example, a shape that is composed of two semicircles that are interposed between two parallel straight portions, and it is on one of the straight portions that the grip elements 10a, 10b perform their useful stroke for the traction of the products 3.

During such straight portion, in fact, the products 3 are packaged by wrapping in a sheet of plastic film and by folding the protruding film flaps at the end of the products 3; at the end of the straight portion, the bundle composed of the products 3 wrapped in the film is delivered to a component that is capable of heat-sealing the folds provided and of expelling the pack.

The remainder of the closed path 2 is used by the grip elements 10a, 10b simply for the return stroke, in order to be able to be repositioned again at the reception of a new group of products 3 delivered by the lifting unit.

The traction device 1 further comprises an apparatus 4 for moving the two grip elements 10a, 10b along the closed path 2.

According to the invention, the traction device 1 comprises means for varying the distance between one, 10a, of the grip elements 10a, 10b and the other one, 10b, during their movement along the closed path 2.

In particular, the movement apparatus 4 comprises at least one driving unit and at least one second driving unit, which is capable of moving independently of each other the respective grip elements 10a, 10b along the closed path 2; the grip elements 10a, 10b are individually associated either with the first driving unit or with the second driving unit.

The distance variation means are therefore comprised within the movement apparatus 4 and it is indeed the simultaneous presence of the first driving unit and of the second driving unit that ensures the possibility to vary, independently of each other, the rules of motion of the respective grip elements 10a, 10b and consequently vary their mutual distance.

Once a group of products 3 has been picked up, each grip element 10a, 10b can in fact be moved by the respective driving unit according to cycles that depend exclusively on criteria that are related to the optimization of the subsequent steps of the wrapping cycle and are mutually independent: the upstream steps set constraints that must be met exclusively by the rule of motion of the subsequent grip element 10b, 10a, which conveniently is independent of the preceding one.

If needed by the optimization requirements of the wrapping cycles, the movement apparatus 4 can comprise a plurality of grip elements 10a, 10b, which are arranged in succession along the closed path 2. Such distance varying means thus act for example on one of the grip elements 10a, 10b that is moving a respective product 3, after picking it up from the lifting unit, and on the subsequent grip element 10b, 10a, which is about to pick up another product 3.

The larger number of active elements (with respect to the embodiment that has only two grip elements 10a, 10b) allows to reduce the operating speed of each of them, ensuring further the possibility to process simultaneously a larger number of products 3, with the result of increasing the efficiency of the traction device 1.

The movement apparatus 4 thus comprises a plurality of driving units, each of which is capable of moving at least one respective grip element 10a, 10b independently of the others.

As is evident, the distance varying means are again comprised within the movement apparatus 4.

According to an embodiment of particular interest in practice, the traction device 1 according to the invention comprises a first series of grip elements 10a and a second series of grip elements 10b; they are arranged alternately along the closed path 2.

During operation, such distance varying means are at all times engaged with at least one grip element 10a of the first series, for example with the one that has just received from the lifting unit a respective product 3, and with the subsequent grip element 10b of the second series, which is about to pick up another product 3 (and vice versa); once they have ended their useful stroke, the variation means move to operate on subsequent grip elements 10a, 10b, according to a cyclic and continuous repetition.

In order to obtain the result that has just been described, all the grip elements 10a of the first series are moved by the first driving unit, while all the grip elements 10b of the second series are moved by the second driving unit.

Again, the distance varying means are thus comprised within the movement apparatus 4: it is in fact again the simultaneous presence of the first driving unit and of the second driving unit that ensures the desired function of variation of the mutual distance between two consecutive grip elements 10a, 10b.

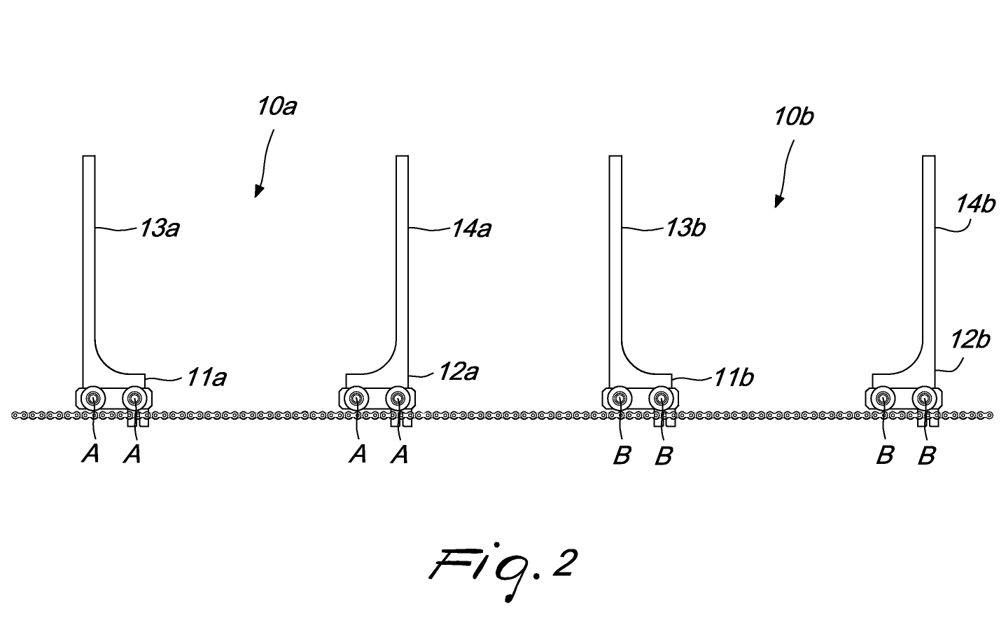

According to an alternative embodiment, with particular reference to the accompanying FIG. 2, each grip element 10a, 10b comprises two sliders 11a, 12a, 11b, 12b. At least one respective tooth 13a, 14a, 13b, 14b protrudes from each slider 11a, 12a, 11b, 12b (at right angles with respect to the closed path 2); therefore, each grip element 10a, 10b is matched by at least two contiguous teeth 13a, 14a, 13b, 14b, which are arranged substantially mutually opposite and are capable of performing the task of retaining a group of products 3.

It should be noted that each grip element 10a, 10b can comprise a plurality of teeth 13a, 14a, 13b, 14b, which are arranged transversely with respect to the advancement direction in order to better provide the grip of the products 3.

The movement apparatus 4 comprises at least one first chain 5a and at least one second chain 5b, which are functionally associated respectively with the first driving unit and with the second driving unit; each chain 5a, 5b is in turn connected to the two sliders 11a, 12a, 11b, 12b that belong to the same grip element 10a, 10b.

In this manner, each driving unit is capable of moving one chain 5a, 5b and correspondingly of pulling, along the closed path 2, the first series of grip elements 10a or the second series of grip elements 10b.

Advantageously, in order to allow the traction device 1 according to the invention to adapt to the different formats of products 3 that must be processed, the device 1 comprises an assembly for adjusting the center distance between the two teeth 13a, 14a, 13b, 14b of each grip element 10a, 10b.

More particularly, the movement apparatus 4 comprises at least four chains 5a, 6a, 5b, 6b, each of which is connected to a respective slider 11a, 12a, 11b, 12b. The adjustment device causes the relative sliding of one of the chains 5a, 6a, 5b, 6b, which is connected to one grip element 10a, 10b, with respect to the other chain 6a, 5a, 6b, 5b, which is connected to the same grip element 10a, 10b.

According to a preferred embodiment, shown by way of example in the accompanying figures, in order to provide the connection between the chains 5a, 6a, 5b, 6b and the sliders 11a, 12a, 11b, 12b, on each one of such sliders there is at least one seat for at least one transverse bar A, B (two in the case shown in the accompanying figures), which is arranged transverse with respect to the advancement direction of the grip elements 10a, 10b.

The grip elements 10a, 10b are thus arranged along the transverse bar A, B, which at one of its ends engages jointly a carriage 15a, 16a, 15b, 16b, which is coupled to the chain 5a, 6a, 5b, 6b by means of a fork 17a, 18a, 17b, 18b. In the other end, each transverse bar A, B can abut against a corresponding guide, in order to give solidity to the structure or, according to the embodiment shown in the accompanying figures, can engage another carriage 15a, 16a, 15b, 16b, which in turn is coupled to another chain 5a, 6a, 5b, 6b.

Along the same transverse bar A, B it is possible to arrange multiple rows of sliders 11a, 12a, 11b, 12b and of teeth 13a, 14a, 13b, 14b, for example four, as shown in the accompanying figures.

According to an alternative embodiment of substantial practical interest, which however does not limit the scope of the invention, the adjustment assembly comprises a first synchronization device and a second synchronization device: the actuation of each of them allows the sliding of a respective chain of one of the grip elements 10a, 10b with respect to the other chain 6a, 5a, 6b, 5b of the same grip element 10a, 10b.

More particularly, each synchronization devices is interposed between a respective driving unit and one of the two chains 5a, 6a, 5b, 6b connected to one of the grip elements 10, 10b. In this manner, its actuation (by means of a movement assembly, for example, which generates a variation in speed between the inlet and the outlet of the synchronization device) produces the relative sliding of the chain 5a, 6a, 5b, 6b with respect to the other chain 6a, 5a, 6b, 5b, which is connected to the same grip element 10a, 10b; the desired adjustment of the center distance is thus obtained.

The operation of the traction device according to the invention is as follows.

The presence of the first driving unit and the second driving unit allows to move independently two grip elements 10a, 10b, and thus vary their mutual distance during their movement along the closed path 2.

The independent movement ensures that the products 3 are picked up in accordance with the rules of motion set by the first various stations that work upstream of the traction device 1 according to the invention; at the same time, the independent motor drive ensures the possibility to vary the pitch (the distance between two successive grip elements 10a, 10b) in the subsequent steps of traction. In this manner, the timings of the subsequent processing steps of the pack are independent; hence, the desired decoupling between the steps occurring upstream of the traction device 1 being considered and those occurring downstream of it are thus obtained.

The presence of the first and second synchronization devices moreover allows to produce a sliding between the two chains 5a, 6a, 5b, 6b that are connected to the same grip element 10a, 10b and thus to assuredly provide the traction device 1 according to the invention with the desired additional function of adjusting the center distance of the teeth 13a, 14a, 13b, 14b.

Moreover, it should be noted that the autonomy in the choices of the operating parameters of the traction device 1 according to the invention allows, for example, to arrange along the closed path 2 a number of grip elements 10a, 10b that is reduced with respect to the ones required in the devices of the background art. In this manner it is possible to reduce the number of sliders 11a, 12a, 11b, 12b and consequently the moved masses. Thus, a line is obtained which as a whole is lighter and therefore requires smaller forces for movement for equal accelerations, with a consequent economic saving provided by the smaller necessary size of the driving units assigned to such movement; reliability is moreover improved, since the smaller forces involved cause less wear of the mechanical elements of the traction system.

The presence of a reduced number of grip elements 10a, 10b further allows to increase significantly the space between two successive sliders 11a, 12a, 11b, 12b, a space that can be utilized conveniently to provide the subsequent steps of the wrapping cycle; as an alternative, by utilizing the reduction of the number of grip elements 10a, 10b it is possible to reduce the dimensions of the traction device 1.

In practice it has been found that the traction device according to the invention fully achieves the intended aim, since the possibility to vary the mutual distance between two grip elements of the product to be packaged allows to decouple the pickup of the products and the upstream steps from the subsequent operations for providing the wrapping cycle.

The invention thus conceived is susceptible of numerous modifications and variations, all of which are within the scope of the appended claims; all the details may further be replaced with other technically equivalent elements.

Moreover, it is noted that anything found to be already known during the patenting process is understood not to be claimed and to be the subject of a disclaimer.

In practice, the materials used, as well as the dimensions, may be any according to requirements and to the state of the art.

Where technical features mentioned in any claim are followed by reference signs, those reference signs have been included for, the sole purpose of increasing the intelligibility of the claims and accordingly such reference signs do not have any limiting effect on the interpretation of each element identified by way of example by such reference signs.

1. A traction device for products to be packaged, comprising:
at least two grip elements which can move along a predefined closed path and can engage the products to be packaged;
an apparatus for moving said at least two grip elements along said closed path; and
s for varying the distance between one of said grip elements and the other one of said grip elements during their movement along said closed path.

2. The traction device according to claim 1, characterized in that said movement apparatus comprises at least one first driving unit and at least one second driving unit for the independent movement along said closed path of respective grip elements which are individually associated with either said first driving unit or said second driving unit, and wherein said distance varying means is a component of said movement apparatus.

3. The traction device according to claim 1, characterized in that it comprises a plurality of grip elements, which are arranged in succession along said closed path, said distance varying means being functionally associated with said plurality of grip elements in order to vary the distance between at least one grip element, during the movement of a respective product, and the subsequent grip element.

4. The traction device according to claim 3, characterized in that said movement apparatus comprises a plurality of said driving units, each one of said driving units being suitable for moving at least one respective grip element, said distance varying means being comprised within said movement apparatus (4).

5. The traction device according to claim 1, characterized in that it comprises a first series of said grip elements and a second series of said grip elements, which are arranged in an alternating succession along said closed path, said distance varying means being functionally associated with said first series and with said second series in order to vary the distance between at least one grip element of said first series, during the movement of a respective product, and the subsequent grip element of said second series, and vice versa.

6. The traction device according to claim 5, characterized in that said movement apparatus comprises at least one first driving unit and at least one second driving unit, said first driving unit being suitable for moving said grip elements of said first series, said second driving unit being suitable for moving said grip elements of said second series, said distance varying means being comprised within said movement apparatus.

7. The traction device according to claim 1, characterized in that each one of said grip elements comprises two sliders, from each of which there protrudes at least one respective tooth, the substantially mutually opposite teeth of each grip element being adapted to grip the products.

8. The traction device according to claim 1, characterized in that said movement apparatus comprises at least one first chain and at least one second chain, which are functionally associated respectively with said first driving unit and with said second driving unit, each one of said two chains being connected to the two sliders of one of said grip elements to entrain it along said closed path.

9. The traction device according to claim 1, characterized in that it further comprises an assembly for adjusting the center distance between the teeth of each one of said grip elements.

10. The traction device according to claim 9, characterized in that said movement apparatus comprises at least four chains, each of which is connected to one of said sliders and is associated with said adjustment assembly, said adjustment assembly causing the relative sliding of one of said chains, connected to one of said grip elements, with respect to the other chain, connected to the same grip element.

11. The traction device according to claim 9, in that said adjustment assembly comprises a first synchronization device and a second synchronization device, the actuation of each of said devices allowing the sliding of a respective chain connected to one of said grip elements with respect to the other chain connected to the same grip element.

12. The traction device according to claim 11, characterized in that each one of said synchronization devices is interposed between a respective driving unit and a corresponding chain that is connected to one of said grip elements, and can be actuated on command in order to allow a variation of the speed of said corresponding chain with respect to the other chain that is connected to the same grip element.
